(19) United States
(12) Patent Application Publication
(10) Pub. No.: US 2007/0157156 A1
(43) Pub. Date: Jul. 5, 2007

(54) Information models and the application life cycle

(75) Inventors: John D. Meier, Bellevue, WA (US); Anandha Murukan, Bellevue, WA (US); Sirnath Vasireddy, Issaquah, WA (US); Michael Dunner, Renton, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/321,153

(22) Filed: Dec. 29, 2005

(51) Int. Cl. G06F 9/44

(52) U.S. Cl. 717/101

(57) ABSTRACT

An information model (e.g., schema) that can incorporate expertise into an application engineering activity—for example, a threats and countermeasures schema can be applied to a threat modeling component to converge knowledge into the activity by identifying categories, vulnerabilities, attacks and countermeasures. The novel schema can create a common framework that converges knowledge with respect to any application engineering activity (e.g., threat modeling, performance modeling). For example, the framework can include lists of threats and attacks that can be acted upon. As well, the framework can include a list of countermeasures based upon the attacks. Additionally, a context precision mechanism can be employed to automatically and/or dynamically determine a context of an application environment. This context can be used to automatically generate an appropriate schema or information model.

### BACKGROUND

Analysis of software systems has proven to be extremely useful to development requirements and to the design of systems. As such, it can be particularly advantageous to incorporate security engineering and analysis into the software development life cycle from the beginning stage of design. Conventionally, the application life cycle lacks security engineering and analysis thereby prompting retroactive measures to address identified issues.

Today, when developing an application, it is oftentimes difficult to predict how the application will react under real-world conditions. In other words, it is difficult to predict security vulnerabilities of an application prior to and during development and/or before completion. Frequently, upon completion, a developer will have to modify the application in order to adhere to real-world conditions and threats of attacks. This modification can consume many hours of programming time and delay application deployment—each of which is very expensive.

Traditionally, designing for application security is oftentimes random and does not produce effective results. As a result, applications and data associated therewith are left vulnerable to threats and uninvited attacks. In most cases, the typical software practitioner lacks the expertise to effectively predict vulnerabilities and associated attacks.

While many threats and attacks can be estimated with some crude level of certainty, others cannot. For those security criterions that can be estimated prior to development, this estimate most often requires a great amount of research and guesswork in order to most accurately determine the criterion. The conventional guesswork approach of security analysis is not based upon any founded benchmark. As well, these conventional approaches are not effective or systematic in any way.

In accordance with traditional application life cycle development, it is currently not possible to proactively (and accurately) address security issues from the beginning to the end of the life cycle. To the contrary, developers often find themselves addressing security and performance issues after the fact—after development is complete. This retroactive modeling approach is extremely costly and time consuming to the application life cycle.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises an information model that can incorporate expertise into an application engineering activity. In one example, a threats and countermeasures schema can be applied to a threat modeling component. More particularly, the threats and countermeasures schema can be applied to an application decomposition component, a threat identifier component and/or a vulnerability identifier component to assist in organizing and grouping attack and vulnerability information. The threats and countermeasures schema can converge knowledge into the activity by identifying categories, vulnerabilities, attacks and countermeasures.

Effectively, the novel schema (e.g., information model) can create a common framework that converges knowledge with respect to a particular application engineering activity (e.g., threat modeling, performance modeling). For example, the framework can include lists of threats that can be acted upon. Similarly, the framework can include a list of attacks that can be acted upon. Still further, the framework can include a list of countermeasures based upon the attacks. In one aspect, the schema can be organized against known application vulnerability categories and therefore can be actionable from a developer's standpoint, from a code analysis standpoint and from an architect's standpoint.

In another aspect, a context precision mechanism can be employed to automatically and/or dynamically determine a context of an application environment. In accordance therewith, an information model can be established based at least in part upon the context. Essentially, the context precision concept can be described as a novel tool that can clarify guidance and product design by defining a set of categories that facilitates highly relevant, highly specific guidance and actions.

In disparate particular aspects, dimensions of the context precision mechanism can be directed to application types, scenarios, project types, life cycles, etc. Accordingly, an the context precision component can evaluate an application environment to determine the application type, for example, is it a web application, web service, a component, a framework, operating system, etc? Using these dimensions, very specific guidance can be generated.

In yet another aspect of the novel innovation, a system that facilitates engineering of an application is provided. More particularly, the system can include an information model configuration component that incorporates engineering expertise into an information model and an application engineering component that executes an engineering activity based at least in part upon the information model. As described supra, in one particular aspect, the information model can include a category identifier, a vulnerability identifier, an attack identifier, and a countermeasure identifier. This predefined expertise can be incorporated into application engineering activities such as, threat modeling, performance modeling, etc.

In still another aspect, an information model can be provided that defines an input validation system. This input validation system can address a specific Web application vulnerability, input and/or data validation. In doing so, the information model can facilitate employing a constrain component that filters good data, a reject component that rejects bad data, and a sanitize component that cleanses the bad data.

Still another aspect of the innovation employs an artificial intelligence (AI) component that infers an action that a user desires to be automatically performed. More particularly, an AI component can be provided and employ a probabilistic and/or statistical-based analysis to prognose or infer an action that a user desires to be automatically performed.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system that facilitates generating and employing an information model in accordance with an aspect of the innovation.

FIG. 2 illustrates a system that employs an information model having multiple categories, issues and remedies defined in accordance with a novel security modeling system.

FIG. 3 illustrates an exemplary list of activities of a security engineering system in accordance with the novel innovation.

FIG. 4 illustrates a system that employs a context precision component that analyzes an application in accordance with an aspect of the innovation.

FIG. 5 illustrates an input validation system in accordance with an aspect of the innovation.

FIG. 6 illustrates an architecture including an artificial intelligence-based component that can automate functionality in accordance with an aspect of the novel innovation.

FIG. 7 illustrates an exemplary flow chart of procedures that facilitate determining a context, generating a schema and applying the schema to an engineering activity in accordance with an aspect of the innovation.

FIG. 8 illustrates a block diagram of a computer operable to execute the disclosed architecture.

FIG. 9 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

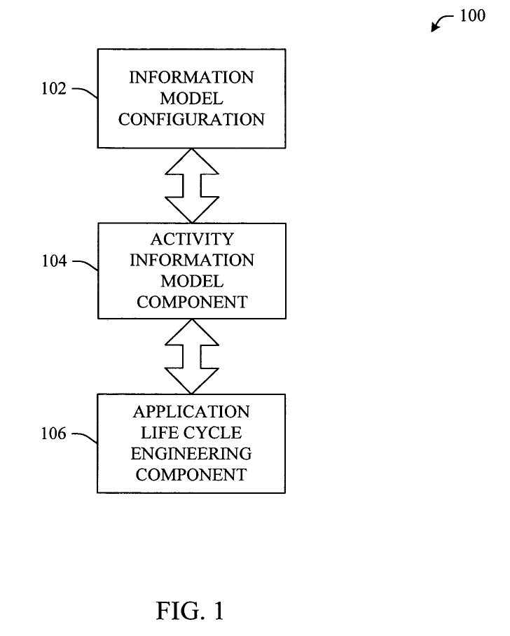

Referring initially to the figures, FIG. 1 illustrates a system 100 that facilitates providing an information model (e.g., frame, schema, template) in accordance with an aspect of the innovation. Generally, system 100 includes an information model component 102 that facilitates generation of an activity information model component 104. The activity information model configuration component 104 can enable specific factors (e.g., categories, issues, remedies) to be defined and input into an application life cycle engineering component 106.

In one aspect, the security frame or information model 104 is a pattern-based information model that defines a set of security-related categories specifically for the application type that is being designed. Frequently, these categories represent the areas where security mistakes are most often made. Patterns and practices security guidance includes context-specific security frames for each major application type.

In one aspect, the subject innovation can provide an information model 104 (e.g., schema, template) that identifies and explains a set of network, host and application layer threats (e.g., issues) and defines countermeasures (e.g., remedies) that are appropriate to address each threat. To this end, the novel information model 10 can facilitate categorization of issues in preparation for performing other life cycle engineering tasks such as threat and/or performance modeling.

Although the following scenario is directed to a Web application, it is to be understood and appreciated that the novel information model mechanisms described herein can be applied to other types of application types and environments as well as other life cycle activities. These alternative aspects are to be included within the scope of this disclosure and claims appended hereto.

The aspect described herein can facilitate analysis of Web application security from the perspectives of threats, vulnerabilities, attacks and countermeasures. The following terms are used throughout the description, the definitions of which are provided herein to assist in understanding various aspects of the subject innovation.

An “asset” refers to a resource of value such as the data in a database or a file system, or a system resource.

A “threat” refers to a potential occurrence—malicious or otherwise—that may harm an asset.

A “vulnerability” refers to a weakness that makes a threat possible.

An “attack” (or “exploit”) refers to an action taken to harm an asset.

A “countermeasure” refers to a safeguard that addresses a threat and mitigates risk.

As described above, the novel information model 104 of the subject innovation can identify a set of common network, host, and application level threats, and the recommended countermeasures to address each one. Although this description does not contain an exhaustive list of threats, vulnerabilities and/or countermeasures, it is to be understood that it does highlight many top threats. With this information and knowledge of how an attacker works, a user can identify additional threats. In other words, the novel information model 104 can educate a user of the threats that are most likely to impact a system.

While there are many variations of specific attacks and attack techniques, it can be particularly useful view threats in terms of what the attacker is trying to achieve. In other words, focus can be shifted from the identification of every specific attack to focusing on the end results of possible attacks. Threats faced by the application can be categorized based on the goals and purposes of the attacks. A working knowledge of these categories of threats can help organize a security strategy so that preparation can be made with respect to responses to threats.

In one aspect particular categories of threat types can be employed. For example, STRIDE is an acronym that can be used to categorize different threat types. More particularly, STRIDE is an acronym for the following:

Spoofing refers to an act of attempting to gain access to a system by using a false identity. This can be accomplished using stolen user credentials or a false IP address. After the attacker successfully gains access as a legitimate user or host, elevation of privileges or abuse using authorization can begin.

Tampering is the unauthorized modification of data, for example as it flows over a network between two computers.

Repudiation is the ability of users (legitimate or otherwise) to deny that they performed specific actions or transactions. Without adequate auditing, repudiation attacks are difficult to prove.

Information disclosure is the unwanted exposure of private data, for example, a user views the contents of a table or file he or she is not authorized to open, or monitors data passed in plaintext over a network. Some examples of information disclosure vulnerabilities include the use of hidden form fields, comments embedded in Web pages that contain database connection strings and connection details, and weak exception handling that can lead to internal system level details being revealed to the client. Any of this information can be very useful to the attacker.

Denial of service is the process of making a system or application unavailable. For example, a denial of service attack might be accomplished by bombarding a server with requests to consume all available system resources or by passing it malformed input data that can crash an application process.

Elevation of privilege occurs when a user with limited privileges assumes the identity of a privileged user to gain privileged access to an application. For example, an attacker with limited privileges might elevate his or her privilege level to compromise and take control of a highly privileged and trusted process or account.

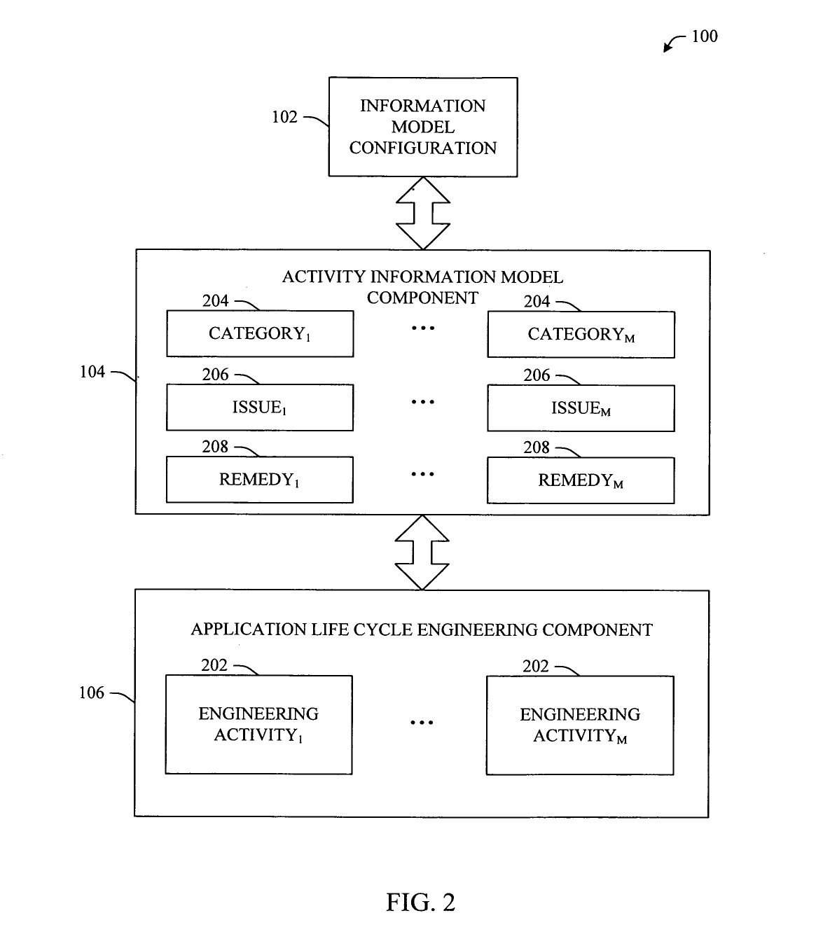

Referring now to FIG. 2, an alternative block diagram of system 100 is shown. More particularly, as illustrated, the application life cycle engineering component can include 1 to M engineering activity components. These 1 to M engineering activity components can be referred to individually or collectively as engineering activity components 202.

Additionally, as shown, activity information model component 104 can include 1 to N category components 204, 1 to P issue components 206 and 1 to R remedy components 208. Each of these activity information model subcomponents (204, 206, 208) will be better understood upon a review of the figures that follow.

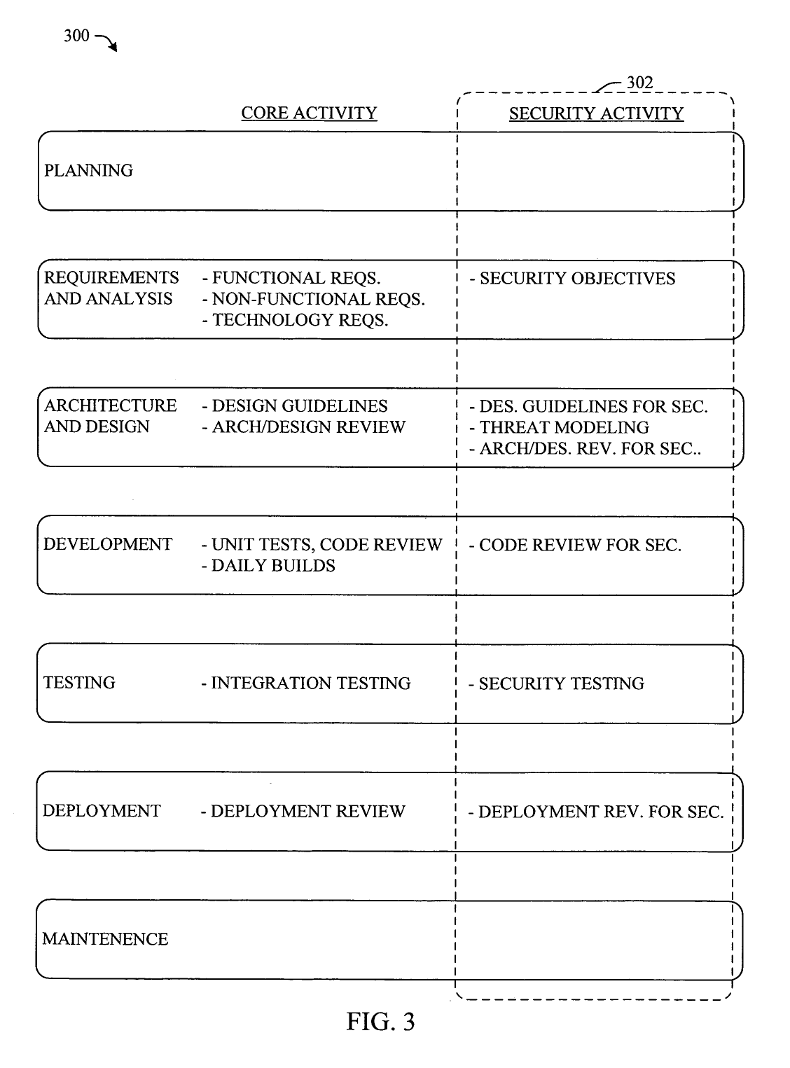

Referring again to the engineering activity components 202 and with reference to FIG. 3, for instance, as the example described herein is directed to a security scenario, in a security engineering environment, the novel information model concepts can be employed in connection with a number of security engineering activities. As shown in FIG. 3, the security engineering life cycle can include a set of proven security-focused activities 302. Expertise can be incorporated into each of these activities through the use of the novel information model(s) described herein.

Although the aspects described herein are directed to a security engineering implementation, (e.g., threat modeling), it is to be understood that the novel information model functionality can be applied to other engineering models and activities associated therewith. By way of example, the novel information model concepts can be applied to a performance engineering model. More particularly, the novel information model mechanisms can be applied to the performance modeling activity of a performance engineering system.

Moreover, it is to be understood and appreciated that the subject security engineering model of FIG. 3 can facilitate the ability to bake security into the application life cycle. In doing so, security focus can be added to the following common security engineering activities:
Design guidelines for security;
Arch and design review for security;
Code review for security;
Deployment review for security; and
Threat modeling to identify security objectives and shape application design.

With reference again to FIG. 2, each issue (e.g., threat) category described by STRIDE can have a corresponding set of countermeasure techniques (e.g., remedies 208) that can be used to reduce risk. These issues 206 and remedies 08 are summarized in the table that follows. It is to be understood that the appropriate countermeasure depends upon the specific attack. Although specific, threats, attacks, and countermeasures that apply at the network, host, and application levels are presented herein, it is to be understood that others exist. These additional threats, attacks and countermeasures are to be included within the scope of this disclosure and claims appended hereto.

| Threat (e.g., | |
|---|---|
| issue 206) | Counter-measures (e.g., remedy 208) |
| Spoofing | Use strong authentication. |
| user identity | Do not store secrets (for example, passwords) in |
| | plaintext. |
| | Do not pass credentials in plaintext over the wire. |
| | Protect authentication cookies with Secure Sockets |
| | Layer (SSL). |
| Tampering | Use data hashing and signing. |
| with data | Use digital signatures. |
| | Use strong authorization. |
| | Use tamper-resistant protocols across communication |
| | links. |
| | Secure communication links with protocols that |
| | provide message integrity. |
| Repudiation | Create secure audit trails. |
| | Use digital signatures. |
| Information | Use strong authorization. |
| disclosure | Use strong encryption. |
| | Secure communication links with protocols that |
| | provide message confidentiality. |
| | Do not store secrets (for example, passwords) in |
| | plaintext. |
| Denial | Use resource and bandwidth throttling techniques. |
| of service | Validate and filter input. |
| Elevation | Follow the principle of least privilege and use |
| of privilege | least privileged service accounts to run processes |
| | and access resources. |

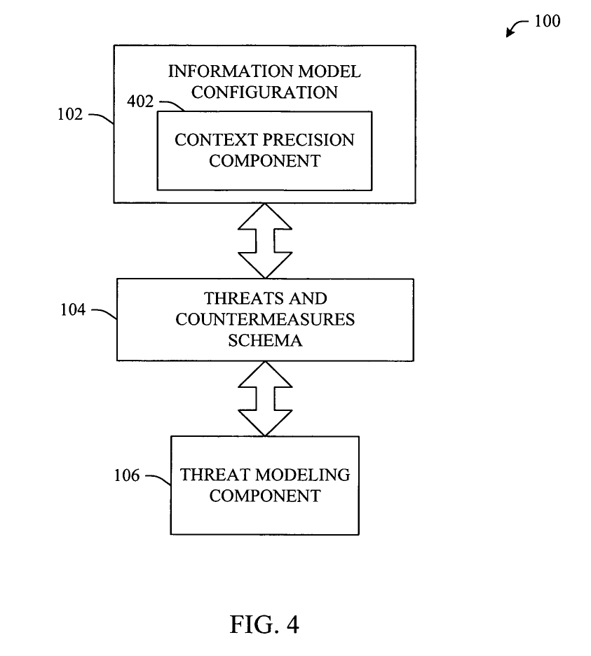

Turning now to FIG. 4 and with continued reference to the example of the threats and countermeasures information model 104, a system 400 that facilitates identification of an appropriate information model 104 is shown. More particularly, information model configuration component 102 can include a context precision component 402 which can automatically determine an application type thereby facilitating determination of an appropriate information model that matches the type.

The novel context precision concept is a tool that can clarify guidance and product design. In other words, the context precision component 402 can generate a set of categories that facilitates highly relevant, highly specific guidance and actions. For example, one dimension can be application type, another dimension can be scenario, another dimension can be project type, and yet another dimension can be life cycle. Accordingly, the context precision component 402 can determine a context of a particular application environment thereby facilitating automatic generation of an appropriate information model 104. For example, the context precision component 402 can be employed to determine if an environment contains a specific application type, for example, a web application, web service, a component, a framework, operating system, etc.

In other aspects, the context precision component 402 can be employed to determine a project type, for example, e-commerce, etc. In still another aspect, the context precision component 402 can determine a particular application scenario, for example, Internet, intranet, etc. In yet another aspect of the innovation, the context precision component 402 can be employed to determine life cycle type, for example, waterfall, MSF Agile, MSF Formal, etc. Using these dimensions, very specific guidance can be generated.

One particularly useful method of analyzing application-level threats is to organize them by application vulnerability category. The table below summarizes an exemplary set of threats by application vulnerability category.

| Vulnerability | |
|---|---|
| Category (e.g., | |
| 204 of FIG. 2) | Threats (e.g., 206 of FIG. 2) |
| Input | Buffer overflow; cross-site scripting; SQL injection; |
| validation | canonicalization |
| Authentication | Network eavesdropping; brute force attacks; |
| | dictionary attacks; cookie replay; credential theft |
| Authorization | Elevation of privilege; disclosure of confidential data; |
| | data tampering; luring attacks |
| Configuration | Unauthorized access to administration interfaces; |
| management | unauthorized access to configuration stores; |
| | retrieval of clear text configuration data; lack of |
| | individual accountability; over-privileged process and |
| | service accounts |
| Sensitive data | Access sensitive data in storage; network |
| | eavesdropping; data tampering |
| Session | Session hijacking; session replay; man in the middle |
| management | |
| Cryptography | Poor key generation or key management; weak or custom |
| | encryption |
| Parameter | Query string manipulation; form field manipulation; |
| manipulation | cookie manipulation; HTTP header manipulation |
| Exception | Information disclosure; denial of service |
| management | |
| Auditing | User denies performing an operation; attacker |
| and logging | exploits an application without trace; attacker |
| | covers his or her tracks |

With particular reference to the exemplary vulnerability category of input validation above, input validation refers to a security issue if an attacker discovers that an application makes unfounded assumptions about the type, length, format, or range of input data. In this exemplary scenario, the attacker can then supply carefully crafted input that compromises the application. Although the specific examples described herein are directed toward the input validation category of vulnerability, it is to be appreciated that the other categories described above are to be included within the scope of this disclosure and claims appended hereto.

It is to be understood that when network and host level entry points are fully secured; the public interfaces exposed by the application become the only source of attack. As such, the input to the application is a means to both test the system and a way to execute code on an attacker's behalf. To this end, it is important not to blindly trust input(s) thereby reducing susceptibility to buffer overflows, cross-site scripting, SQL injection, canonicalization, etc.—each of which can be reduced by validating input(s).

By way of further example, buffer overflow vulnerabilities can lead to denial of service attacks or code injection. A denial of service attack causes a process crash. Code injection alters the program execution address to run an attacker's injected code.

A cross-site scripting (XSS) attack can cause arbitrary code to run in a user's browser while the browser is connected to a trusted Web site. The attack targets the application's users and not the application itself, but it uses the application as the vehicle for the attack. Because the script code is downloaded by the browser from a trusted site, the browser has no way of knowing that the code is not legitimate. All in all, input validation can address XSS attacks.

Continuing with the example, an SQL injection attack exploits vulnerabilities in input validation to run arbitrary commands in the database. It can occur when the application uses input to construct dynamic SQL statements to access the database. It can also occur if the code uses stored procedures that are passed strings that contain unfiltered user input. Using the SQL injection attack, the attacker can execute arbitrary commands in the database. It will be appreciated that the issue can be magnified if the application uses an over-privileged account to connect to the database. In this instance it is possible to use the database server to run operating system commands and potentially compromise other servers, in addition to being able to retrieve, manipulate, and destroy data.

Different forms of input that resolve to the same standard name (the canonical name), is referred to as “canonicalization.” Code can be particularly susceptible to canonicalization issues if it makes security decisions based on the name of a resource that is passed to the program as input. Files, paths, and URLs are resource types that are vulnerable to canonicalization because in each case there are many different ways to represent the same name. File names are also problematic.

All in all, by being aware of the typical approach used by attackers as well as their goals, a software engineer or other user can be more effective when applying countermeasures. It is also to be understood that it is particularly useful to use a goal-based approach when considering and identifying threats, and to use the STRIDE model to categorize threats based on the goals of the attacker, for example, to spoof identity, tamper with data, deny service, elevate privileges, and so on. This information can be employed within the novel information model 104 thereby providing knowledge of these threats, together with the appropriate countermeasures, which provides essential information for the threat modeling process. Moreover, the novel context precision component 402 together with the threats and countermeasures schema 104 can enable identification of the threats that are specific to a particular scenario and prioritization of the threats based on the degree of risk they pose to the system.

As described supra, a set of secure design guidelines for application design can be provided via a novel information model (e.g., schema, template) 104. In the aspects described herein, the guidelines can be organized by common application vulnerability category including input validation, authentication, authorization, configuration management, sensitive data, session management, cryptography, parameter manipulation, exception management and auditing and logging. It is to be understood that these represent the key areas for Web application security design, where mistakes are commonly made.

Continuing with the example described herein, Web applications frequently present a complex set of security issues for architects, designers, and developers. The most secure and hack-resilient Web applications are those that have been built from the ground up with security in mind. This proactive design can be employed via the novel information model functionality described supra.

It will be appreciated that Web applications present designers and developers with many challenges. The stateless nature of HTTP means that tracking per-user session state becomes the responsibility of the application. As a precursor to this, the application must be able to identify the user by using some form of authentication. Given that all subsequent authorization decisions are based on the user's identity, it is essential that the authentication process is secure and that the session handling mechanism used to track authenticated users is equally well protected. Designing secure authentication and session management mechanisms are just a couple of the issues facing Web application designers and developers. Other challenges occur because input and output data passes over public networks. Preventing parameter manipulation and the disclosure of sensitive data are other top issues.

Referring again to the discussion of the input validation vulnerability category, input validation is a challenging issue and one primary burden of a solution that falls on application developers. However, proper input validation can be one of the strongest measures of defense against today's application attacks. Proper input validation is an effective countermeasure that can help prevent XSS, SQL injection, buffer overflows, and other input attacks.

Input validation is challenging because there is not a single answer for what constitutes valid input across applications or even within applications. Likewise, there is no single definition of malicious input. Adding to this difficulty is that what the application does with this input influences the risk of exploit. For example, do you store data for use by other applications or does your application consume input from data sources created by other applications?

As described above, conventionally, the software industry does not have a common (or systematic) technique to learn about, harvest, share principles, practices, patters, anti-patterns around security threats, vulnerabilities and/or countermeasures. As well, the relationships between different aspects of security problems is another issue. These and other scenarios can be addressed by the novel information model 104 described herein—this expertise can be incorporated within the novel information model 104 described herein.

The following practices can improve a Web application's input validation:
Assume all input is malicious;
Centralize your approach;
Do not rely on client-side validation;
Be careful with canonicalization issues; and
Constrain, reject, and sanitize your input.

It is particularly prudent to assume that all inputs are malicious in nature. Input validation starts with a fundamental supposition that all input is malicious until proven otherwise. Whether input comes from a service, a file share, a user, or a database, the input should be validated if the source is outside the trust boundary. For example, if an external Web service is called that returns strings, it is not possible to know if malicious commands are present or not. Similarly, if several applications write to a shared database, when data is read, it is difficult to determine if it is safe.

Input validation strategy can be considered a core element of the application design. As such, expertise related thereto can be incorporated into the novel information model 104. In other words, the subject innovation can provide for a centralized approach to input validation, for example, by using common validation and filtering code in shared libraries. This can ensure that validation rules are applied consistently. It can also reduce development effort and assist with future maintenance.

In many cases, individual fields require specific validation, for example, with specifically developed regular expressions. However, common routines can frequently be factored out to validate regularly used fields such as e-mail addresses, titles, names, postal addresses including ZIP or postal codes, etc.

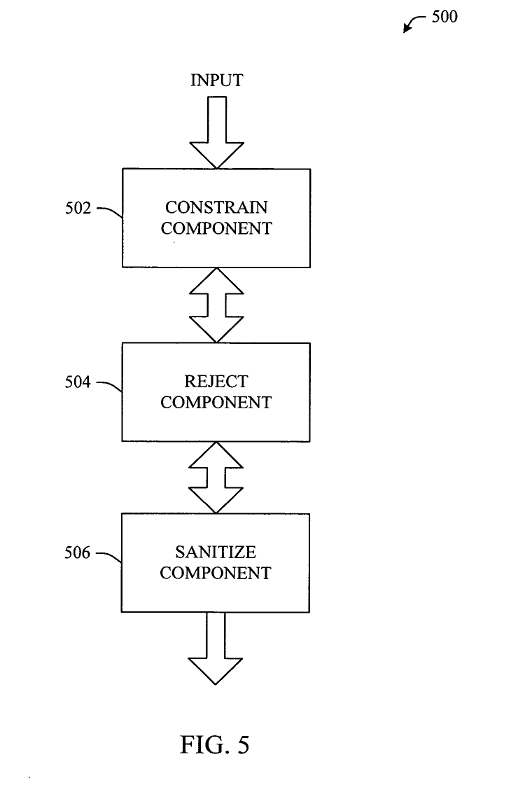

FIG. 5 illustrates an input validation system 500 in accordance with an aspect of the innovation. Generally, the system 500 can include a constrain component 502, a reject component 504 and a sanitize component 506. As will be understood upon a review of FIG. 5, one preferred approach to validating input is to proactively constrain allowable data. It can be particularly easier to validate data for known valid types, patterns, and ranges than it is to validate data by looking for known bad characters.

In accordance with the novel information model 104 described supra, when an application is designed, it is possible to know what the application expects. This information can be proactively incorporated within the engineering model activity. In other words, the range of valid data is generally a more finite set than potentially malicious input. In an alternative aspect, for defense in depth, it may be prudent to reject known bad input and then sanitize the input. One such strategy is shown in FIG. 5, system 500.

To create an effective input validation strategy, it can be useful to be aware of the following approaches and their tradeoffs:
Constrain input;
Validate data for type, length, format, and range;
Reject known bad input; and
Sanitize input.

Constraining input refers to a technique of allowing known good data. The idea here is to define a filter of acceptable input by using type, length, format, and range. In other words, the information model 104 can define acceptable input for application fields. These acceptable inputs can be enforced via the constrain component 502. All other data can be rejected as bad data. In one aspect, constraining input can involve setting character sets on the server so that you can establish the canonical form of the input in a localized way.

Other aspects can employ validation of data for type, length, format and range. By way of example, strong type checking of input data can be employed, for instance, in the classes used to manipulate and process the input data and in data access routines. By way of further example, parameterized stored procedures for data access can be employed to benefit from strong type checking of input fields.

String fields can also be length checked and in many cases checked for appropriate format. For example, ZIP codes, personal identification numbers, etc. utilize well defined formats that can be validated using regular expressions. It will be appreciated that thorough checking is not only good programming practice; it can make it more difficult for an attacker to exploit your code. The attacker may get through your type check, but the length check may make executing the favorite attack more difficult.

The optional reject component 504 can be employed to reject known bad input(s). As described supra, denying “bad” data can be employed as an alternative and/or additional technique to validate input. It is to be understood that this approach is generally less effective than using the “allow” approach described earlier and it can be best used in combination. To deny bad data assumes the application knows all the variations of malicious input—which is frequently not the case. This is one reason why it can be prudent to employ the reject component 504 in additional to allowing good data.

While useful for applications that are already deployed and when significant changes are not desired, the “deny” approach is not as robust as the “allow” approach. This is because bad data, such as patterns that can be used to identify common attacks, do not remain constant. Valid data remains constant while the range of bad data may change over time.

The sanitize component 506 can be employed to make data safe. “Sanitizing” refers to making malicious, or potentially malicious, data safe. It can be particularly helpful when the range of input that is allowed cannot guarantee that the input is safe. By way of example, it is to be understood that this includes anything from stripping a null from the end of a user-supplied string to escaping out values so they are treated as literals.

In operation, while the following examples are not to be considered exhaustive, they represent examples applied to common input fields, using the preceding approach:
Last Name field—this is an example where constraining input can be appropriate. In this case, string data in the range ASCII A-Z and a-z can be allowed, and also hyphens and curly apostrophes (curly apostrophes have no significance to SQL) to handle names such as O'Dell. The length can also be limited to the longest expected value.
Quantity field—this is another case where constraining input can be employed. In this example, a simple type and range restriction can be employed. For example, the input data may require be a positive integer between 0 and 1000. Free-text field—Examples include comment fields on discussion boards. In this case, letters, spaces, and common characters such as apostrophes, commas, and hyphens may be allowed. In one aspect, the set that is allowed does not include less than and greater than signs, brackets, and braces.
An existing Web application that does not validate user input—In an ideal scenario, the application can check for acceptable input for each field or entry point. However, in the case of an existing Web application that does not validate user input, a stopgap approach can be employed to mitigate risk until the application's input validation strategy can be improved. While neither of the following approaches ensures safe handling of input, because that is dependent on where the input comes from and how it is used in your application, they can be employed as quick fixes for short-term security improvement:
   HTML-encoding and URL-encoding user input when writing back to the client. In this case, the assumption is that no input is treated as HTML and all output is written back in a protected form. This situation is sanitization in action.
   Rejecting malicious script characters—this is a case of rejecting known bad input. In this case, a configurable set of malicious characters can be employed to reject the input. As described earlier, one problem with this approach is that bad data is a matter of context.

With reference to the Web application aspects, the novel Web application security frame (e.g., information model, schema) can define a set of vulnerability categories for Web applications. As described above, these categories can represent areas where mistakes are most often made. Additionally, they represent those areas where it may be particularly advantageous to focus additional attention. In this aspect, the categories defined by the Web application security frame represent categories that have been derived by security experts who have examined and analyzed the top security issues across many Web applications. As such, the categories have been refined with input from consultants, product support engineers, customers, and partners.

Following is a table that summarizes exemplary categories that can be represented within a novel Web application security frame in accordance with an aspect of the innovation.

| Category | Description |
|---|---|
| Input and Data | How do you know that the input that the application |
| Validation | receives is valid and safe? |
| | Input validation refers to how the application filters, |
| | scrubs, or rejects input before additional processing. |
| Authentication | Who are you? |
| | Authentication is the process where an entity proves |
| | the identity of another entity, typically through |
| | credentials, such as a user name and password. |
| Authorization | What can you do? |
| | Authorization is how the application provides access |
| | controls for resources and operations. |
| Configuration | Who does your application run as? |
| Management | Which databases does it connect to? |
| | How is your application administered? |
| | How are these settings secured? |
| | Configuration management refers to how the |
| | application handles these operational issues. |
| Sensitive Data | How does your application handle sensitive data? |
| | Sensitive data refers to how your application handles |
| | any data that must be protected either in memory, over |
| | the network, or in persistent stores. |
| Session | How does your application handle and protect user |
| Management | sessions? |
| | A session refers to a series of related interactions |
| | between a user and the Web application. |
| Cryptography | How are you keeping secrets (confidentiality)? |
| | How are you tamper-proofing your data or libraries |
| | (integrity)? |
| | How are you providing seeds for random values that |
| | must be cryptographically strong? |
| | Cryptography refers to how the application enforces |
| | confidentiality and integrity. |
| Parameter | How does your application manipulate parameter values? |
| Manipulation | |
| | Form fields, query string arguments, and cookie |
| | values are frequently used as parameters for an |
| | application. Parameter manipulation refers to both |
| | how the application safeguards tampering of these |
| | values and how the application processes input |
| | parameters. |
| Exception | When a method call in your application fails, what |
| Management | does the application do? |
| | How much do you reveal? |
| | Do you return friendly error information to end users? |
| | Do you pass valuable exception information back to |
| | the caller? |
| | Does your application fail gracefully? |
| Auditing and | Who did what and when? |
| Logging | Auditing and logging refer to how the application |
| | records security-related events. |

The novel frame functionality described herein can be employed to identify threats and vulnerabilities. During threat identification, the frame can be employed to identify common threats pertinent to the application architecture. As described supra, a novel context precision component 402 can be employed to determine an application context thereby facilitating configuration of an appropriate frame in accordance with an aspect of the innovation. To identify vulnerabilities, the application can be reviewed layer by layer, considering each of the vulnerability categories in each layer.

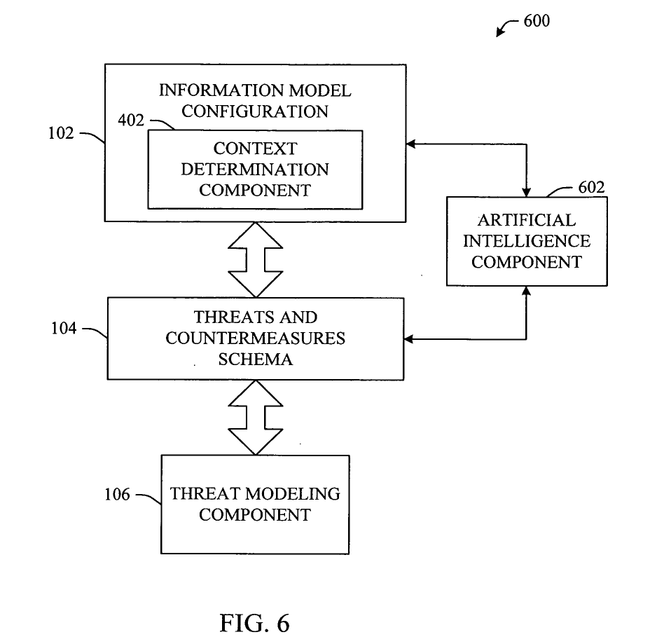

FIG. 6 illustrates a system 600 that employs an artificial intelligence (Al) component 602 which facilitates automating one or more features in accordance with the subject innovation. The subject innovation (e.g., determining an application type, security frame, etc.) can employ various AI-based schemes for carrying out various aspects thereof. For example, a process for determining a threats, vulnerabilities and/or countermeasures can be facilitated via an automatic classifier system and process.

A classifier is a function that maps an input attribute vector, x=(x1, x2, x3, x4, xn), to a confidence that the input belongs to a class, that is, f(x)=confidence (class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria threats, vulnerabilities and/or countermeasures.

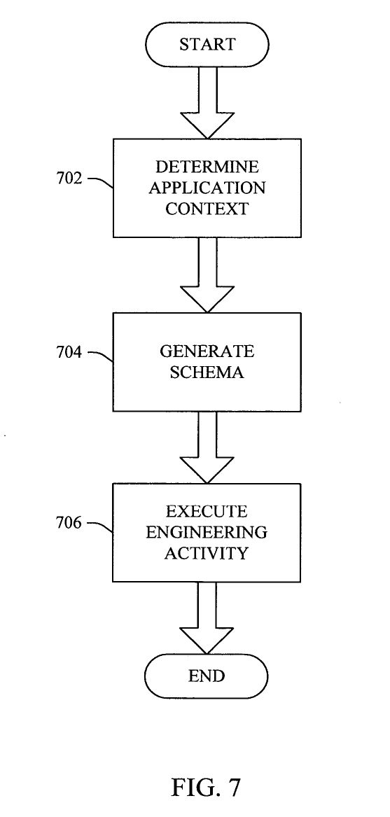

FIG. 7 illustrates a methodology of establishing an information model in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 702, the context can be determined of an application and/or system. In other words, in one aspect, a context precision mechanism can be employed to analyze a application thereby establishing an application type, project type, scenario, life cycle type, etc. The gathered information can be employed in order to generate a schema at 704.

At 704, in one aspect of the innovation, a security information model can be established that defines one or more categories, vulnerabilities, attacks and/or countermeasures. This security information model can facilitate incorporating expertise into an engineering activity at 706. For example, the security information model facilitates incorporating expertise into a security modeling activity. In another example, a schema (e.g., information model) can be generated at 704 which facilitates incorporating expertise into a performance model. It is to be understood and appreciated that other schemas (e.g., templates) can be established which facilitate incorporating expertise into other engineering activities.

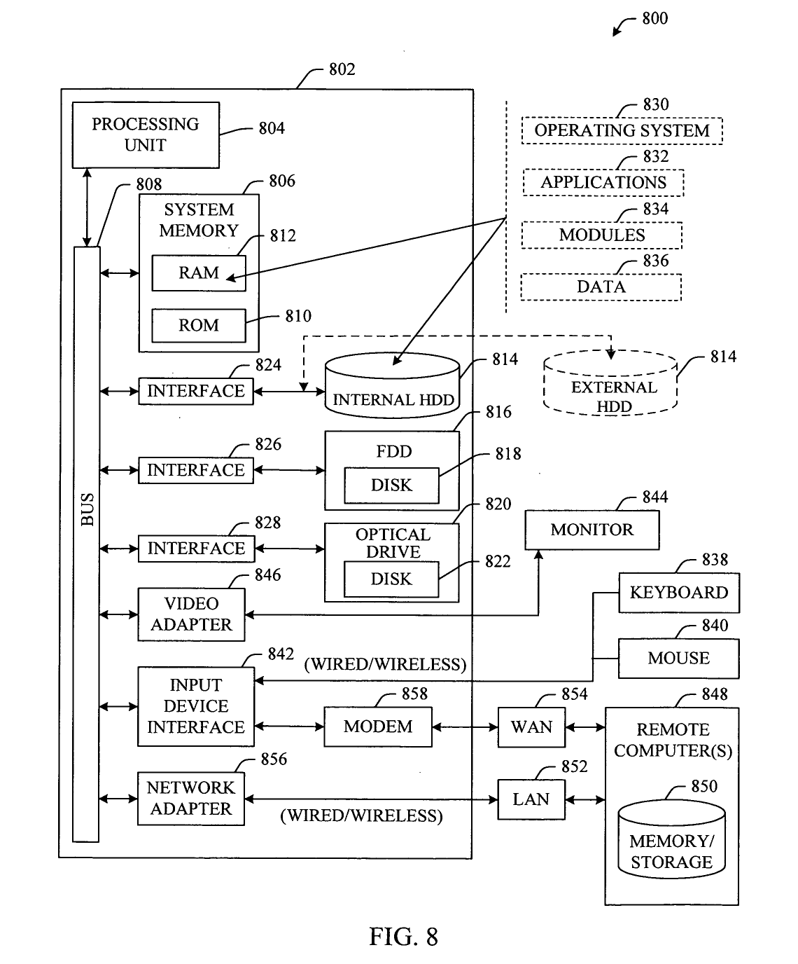

Referring now to FIG. 8, there is illustrated a block diagram of a computer operable to execute the disclosed architecture. In order to provide additional context for various aspects of the subject innovation, FIG. 8 and the following discussion are intended to provide a brief, general description of a suitable computing environment 800 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 8, the exemplary environment 800 for implementing various aspects of the innovation includes a computer 802, the computer 802 including a processing unit 804, a system memory 806 and a system bus 808. The system bus 808 couples system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 includes read-only memory (ROM) 810 and random access memory (RAM) 812. A basic input/output system (BIOS) is stored in a non-volatile memory 810 such as ROM, EPROM, EEPROM, which BIOS contains the basic routines that help to transfer information between elements within the computer 802, such as during start-up. The RAM 812 can also include a high-speed RAM such as static RAM for caching data.

The computer 802 further includes an internal hard disk drive (HDD) 814 (e.g., EIDE, SATA), which internal hard disk drive 814 may also be configured for external use in a suitable chassis (not shown), a magnetic floppy disk drive (FDD) 816, (e.g., to read from or write to a removable diskette 818) and an optical disk drive 820, (e.g., reading a CD-ROM disk 822 or, to read from or write to other high capacity optical media such as the DVD). The hard disk drive 814, magnetic disk drive 816 and optical disk drive 820 can be connected to the system bus 808 by a hard disk drive interface 824, a magnetic disk drive interface 826 and an optical drive interface 828, respectively. The interface 824 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 812, including an operating system 830, one or more application programs 832, other program modules 834 and program data 836. All or portions of the operating system, applications, modules, and/or data can also be cached in the RAM 812. It is appreciated that the innovation can be implemented with various commercially available operating systems or combinations of operating systems.

A user can enter commands and information into the computer 802 through one or more wired/wireless input devices, e.g., a keyboard 838 and a pointing device, such as a mouse 840. Other input devices (not shown) may include a microphone, an IR remote control, a joystick, a game pad, a stylus pen, touch screen, or the like. These and other input devices are often connected to the processing unit 804 through an input device interface 842 that is coupled to the system bus 808, but can be connected by other interfaces, such as a parallel port, an IEEE 1394 serial port, a game port, a USB port, an IR interface, etc.

A monitor 844 or other type of display device is also connected to the system bus 808 via an interface, such as a video adapter 846. In addition to the monitor 844, a computer typically includes other peripheral output devices (not shown), such as speakers, printers, etc.

The computer 802 may operate in a networked environment using logical connections via wired and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which may connect to a global communications network, e.g., the Internet.

When used in a LAN networking environment, the computer 802 is connected to the local network 852 through a wired and/or wireless communication network interface or adapter 856. The adapter 856 may facilitate wired or wireless communication to the LAN 852, which may also include a wireless access point disposed thereon for communicating with the wireless adapter 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wired or wireless device, is connected to the system bus 808 via the serial port interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

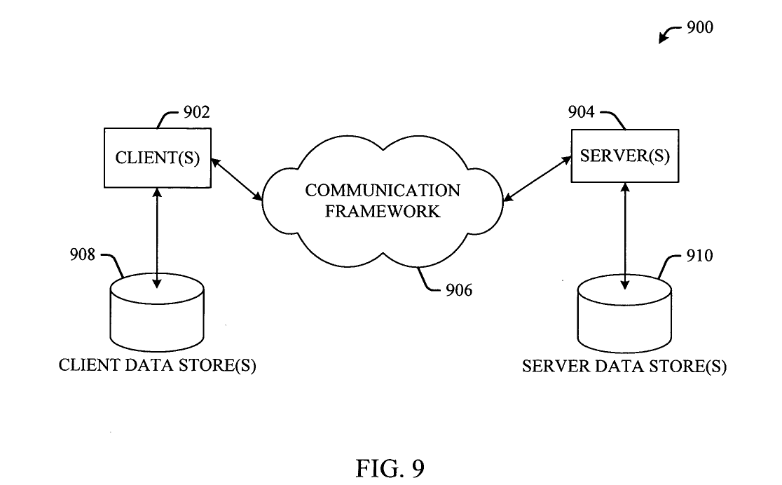

Referring now to FIG. 9, there is illustrated a schematic block diagram of an exemplary computing environment 900 in accordance with the subject innovation. The system 900 includes one or more client(s) 902. The client(s) 902 can be hardware and/or software (e.g., threads, processes, computing devices). The client(s) 902 can house cookie(s) and/or associated contextual information by employing the innovation, for example.

The system 900 also includes one or more server(s) 904. The server(s) 904 can also be hardware and/or software (e.g., threads, processes, computing devices). The servers 904 can house threads to perform transformations by employing the innovation, for example. One possible communication between a client 902 and a server 904 can be in the form of a data packet adapted to be transmitted between two or more computer processes. The data packet may include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates engineering of an application, comprising:
an information model configuration component that incorporates engineering expertise into an information model; and
an application engineering component that executes an engineering activity based at least in part upon the information model.

2. The system of claim 1, the information model comprises:
a category identifier;
a vulnerability identifier;
an attack identifier; and
a countermeasure identifier.

3. The system of claim 1, the engineering activity is at least one of a security objective definition, a threat modeling, a code review and a deployment review activity.

4. The system of claim 1, further comprising a context precision component that analyzes the application and establishes a context; the information model is based at least in part upon the context.

5. The system of claim 4, the context defines at least one of an application type, a project type, and a life cycle type.

6. The system of claim 1, the information model defines an input validation system.

7. The system of claim 6, the input validation system includes a constrain component that filters good data.

8. The system of claim 7, the input validation system further comprises a reject component that rejects bad data.

9. The system of claim 8, the input validation system further comprises a sanitize component that cleanses the bad data.

10. The system of claim 1, further comprising an artificial intelligence (AI) component that infers an action that a user desires to be automatically performed.

11. A computer-implemented method of engineering an application, comprising:
generating a schema; and
executing an application engineering activity based at least in part upon the schema.

12. The computer-implemented method of claim 11, further comprising determining a context of the application and incorporating the context into the act of generating the schema.

13. The computer-implemented method of claim 12, the context includes at least one of an application type, a project type and a life cycle type.

14. The computer-implemented method of claim 11, schema comprises:
a category identifier;
a vulnerability identifier;
an attack identifier; and
a countermeasure identifier.

15. The computer-implemented method of claim 11, the schema defines at least one of a data validation system, an authentication system, an authorization system, a configuration management system, a session management system and an auditing and logging system.

16. A computer-executable system that facilitates engineering of an application, comprising:
means for identifying a context of the application;
means for converging knowledge based at least in part upon the context; and
means for performing an application engineering activity based at least in part upon the knowledge.

17. The computer-executable system of claim 16, the means for converging knowledge is a template.

18. The computer-executable system of claim 17, the means for identifying the context is a context precision component.

19. The computer-executable system of claim 18, the engineering activity is a threat modeling activity.

20. The computer-executable system of claim 18, the engineering activity is a performance modeling activity.
